(19) United States
(12) Patent Application Publication
(10) Pub. No.: US 2017/0251310 A1
(43) Pub. Date: Aug. 31, 2017

(54) METHOD AND DEVICE FOR THE CONFIGURATION OF A USER SPECIFIC AUDITORY SYSTEM

(71) Applicant: audiosus GmbH, Sugenheim (DE)

(72) Inventors: Christoph Stinn, Sugenheim (DE); Peter Moeckel, Suelzfeld (DE)

(21) Appl. No.: 15/443,027

(22) Filed: Feb. 27, 2017

(30) Foreign Application Priority Data
Feb. 25, 2016 (DE) 10 2016 103 297.2

(51) Int. Cl. H04R 25/00

(52) U.S. Cl. CPC H04R 25/505; H04R 25/43; H04R 2225/43

(57) ABSTRACT

A device configuring a user-specific hearing system includes a sound generator for generating sound events and a control unit. At least one loudspeaker at a distance from the user of the hearing system and a control unit for reproducing sound events is provided. The control unit causes the sound generator to generate sound events with different frequencies in a predetermined sequence. The generated sound events are amplified and transmitted for reproduction as sound events with the same loudness to the loudspeaker unit or reproduced directly by the hearing system. The control unit receives evaluation data representing a user-perceived loudness difference between repeated sound events adjacent in the frequency range. The control unit generates correction values which are outputted and can be used in the hearing system in order to configure its converter unit in such a manner that the perceived loudness difference is reduced or preferably eliminated.

### FIELD

The present invention relates to a device and to a method for the configuration of a user-specific hearing system. Such a hearing system traditionally comprises a receiving unit for receiving sound events, an amplification unit for the frequency-dependently variable amplification of the received sound events and a reproduction unit for the reproduction of the amplified sound events to the hearing organ of a user.

In order to make better hearing possible for users with reduced hearing, today complex hearing systems are offered which perform an amplification of sound events and make the amplified sound signals available to the user on his ear on one side of or on both sides. In order to optimize the supported hearing, it is necessary that the amplification characteristic of the hearing system is adapted to the user-specific hearing damage since a frequency-dependent deterioration of the natural hearing is usually given, so that a linear amplification of all sound events would not lead to the desired result. Modern hearing systems allow a frequency-dependent amplification by an adjustment of the parameters, which is preferably carried out during an initial configuration of the hearing system by an auditory specialist for hearing devices.

### BACKGROUND

EP 1 746 859 B1 describes a method for the configuring of a hearing device for a person. To this end an audiometer which generates test tones and an open headphone worn by the user and connected to the audiometer for transmitting the test tones is used. During the configuration, the user wears his hearing devices and the open headphones. The hearing device is configured to amplify in a frequency-specific manner the signal emitted by the audio meter via the headphones until reaching the hearing threshold of the patient. However, it turned out in practice that the configuration of a hearing system by a frequency-specific amplification up to the reaching of the hearing threshold of the user does not lead to satisfactory results. During the configuration of the hearing system it is difficult for the user to precisely identify the occurrence of an amplified signal to the hearing threshold.

DE 10 2007 054 152 A1 teaches a method for the evaluation of the hearing capacity of persons and for the programming of hearing aids. The test person is positioned here in a test chamber at a distance from a loudspeaker array, whereupon test tones are reproduced by the loudspeaker array which spatially represent virtual tone sources by wave field synthesis. The test person should subsequently express his opinion about the perceived strength of the test tones heard in order to determine an auditory image of the test person in this manner. The subjective perceiving of the test persons regarding the test tones is compared with the hearing perception of a person with normal hearing and an auditory image of the test patient is determined.

DE 10 2011 104 536 A1 describes a method and a device for the selecting and configuring of a hearing device for the patient. The patient is at first subjected to a general screening in order to determine his hearing threshold. Subsequently, the patient is provided with a hearing device and exposed to sound waves of increasing strength in a free auditory field with fixed signals until he recognizes that he perceived signals. The hearing device is preset using these recognitions. Subsequently, threshold values for the auditory threshold, the comfortable hearing range and the unpleasant range are adjusted on the hearing device.

U.S. Pat. No. 6,201,875 B1 describes a method for the adaptation of a hearing device. Here, a set of stimuli of impulses, among other things, is made available which comprises a plurality of loudness levels for a plurality of the frequencies. In one method step each loudness level is compared for each frequency or for the perceived equality. The tones to be compared are made available by the hearing device and not by a loudspeaker arrangement simulating environmental conditions.

The problem of the present invention consists, starting from the prior art, in making available an improved method and an improved device which allow a configuration of a user-specific hearing system, so that the auditory experience of the user is optimized after the configuration. The method and the device should be designed to be as simple as possible in order to make possible a usage in customary practices of auditory specialists and to not require too much from the user during the configuration.

This problem is solved by a method according to the attached claim 1 or 4 as well as by a device according to the attached claim 7.

### SUMMARY

The invention is based at first on the approach that the two adjacent sound events are compared which are successively reproduced for the user. The first and the second sound event are evaluated by the user and the hearing system is adapted by the conversion unit by at least one conversion factor so that the loudness of the first sound event is perceived by the user of the hearing system as equal to the loudness of the second sound event. The hearing system of the user is not configured in an improved manner until by the using of adjacent frequencies, for example, at an interval of 1 kHz (±100 Hz).

A device according to the invention for the configuration of a user-specific hearing system comprises a sound generator for generating sound events (subsequently also designated as tone signals) as well as a control unit. At least one loudspeaker at a distance from the user of the hearing system as well as a control unit for the reproduction of the sound events is provided. Alternatively, the sound events can also be generated by the hearing system and reproduced. The control unit causes the sound generator, which can be formed in certain applications by the hearing system, to generate several sound events with different frequencies in a predetermined sequence. These can be narrow-band sinusoidal signals or even tone signals with a greater bandwidth. The generated sound events are adapted in a predetermined manner controlled by the control unit, in particular amplified, and transmitted for reproduction as sound events with the same loudness to the loudspeaker unit or reproduced directly by the hearing system. The control unit receives evaluation data via an operator interface which represent a loudness difference perceived by the user between repeated sound events which are adjacent in the frequency range. Therefore, the control unit signals via the operator interface whether the user perceives the sound events reproduced with the same loudness with a different frequency as equally loud or differently loud. The control unit then generates correction values which are outputted and can be used in the hearing system in order to configure its converter unit in such a manner that the perceived loudness difference is reduced or preferably eliminated.

In contrast to a system such as was described, for example, in DE 10 2007 054 152 A1, according to the present invention the loudspeaker or loudspeakers is/are set up at a distance of preferably 2 m from the user of the hearing system. A loudspeaker array is not necessary for the conversion of the invention but is possible. It is also not necessary for the carrying out of the invention to record a tone audiogram. Whereas traditional systems usually only have as their goal a fine adaptation of the hearing system, the invention directly allows the complete configuration of the hearing system. In contrast to the prior art, a preliminary basic adjustment of the hearing system is not necessary. Also, a preliminary measuring of the audiological characteristic data can be eliminated.

Known systems such as is known, for example, from DE 10 2011 104 536 A1 used noises which are located in the vicinity of the hearing threshold. In the case of an adjustment of hearing systems with such signals close to the threshold, there is the disadvantage that many parameters in the hearing system can have a falsification of the results as a consequence. In addition, a comparison of tones close to the threshold with each other is very difficult for the user. Instead of this, the present invention uses tone signals which are distinctly above the threshold and which can therefore be distinctly heard for a user with normal hearing. Tone signals with a level of 45-80 dB is preferably used.

According to a preferred embodiment the sound events from the sound generator are generated as sinusoidal tones, thirds or narrow-band noise.

The operator interface preferably comprises an input unit and a display unit which can be combined, for example, in a single device such as a PC tablet.

According to a preferred embodiment the device comprises a temporary data connection between the control unit and the hearing system so that the correction values can be directly transmitted to the hearing system. The data connection can be cable-bound or can be constructed with wireless transmission systems. Alternatively, the correction values can of course also be programmed into the hearing system by another operator interface.

The method according to the invention for the configuration of a user-specific hearing system starts with the step of the reproduction of a first sound event with a first frequency and a predetermined loudness in a loudspeaker, preferably in a loudspeaker unit with at least two channels which has at least two loudspeakers separated from each other and from the user of the hearing system. In the next step the reproduction of a second sound event takes place with a second, adjacent frequency deviating from the first frequency and with the same loudness as the first sound event via the loudspeaker unit or the individual loudspeaker. Taking into account a loudness difference perceived by the user between the two sound events, subsequently at least one conversion factor of the converter unit of the hearing system is changed so that the loudness of the first sound event is perceived by the user of the hearing system as equal to the loudness of the second sound event.

The goal of the method is achieved when all frequencies still audible by the user were adapted to the curves of the same loudness.

The previously cited steps are preferably multiply repeated using deviating, adjacent frequencies of the particular sound events to be compared so that the hearing system can be configured over a given frequency range so that subsequently all sound events are perceived by the user with the same loudness. The adjacent sound events compared with each other are spaced from each other by approximately 500 to 1200 Hz, i.e., they differ preferably by approximately 1 kHz±200 Hz, especially preferably by 1 KHz±100 Hz, wherein, of course, even other differences in the cited range are possible. The differences are preferably selected according to the parameter ranges of the hearing system to be adjusted. In the lower frequency range, i.e., below 1 kHz, the intervals between adjacent sound events are preferably to be selected smaller in order to also be able to include even more sound events in this area with different, adjacent frequencies into the configuration loop. In the higher frequency range, i.e., above 6 kHz, the intervals between adjacent sound events are preferably to be selected larger in order to be able to configure an easily comprehensible number of sound events with different, adjacent frequencies in this range.

According to a modified embodiment a multiple change between the frequencies of the reproduced sound events takes place during the configuration and/or a gradual approximation of the loudness of adjacent frequencies up to the same level.

In an expanded embodiment the device according to the invention is completely automated. To this end the method is adapted in such a manner that the acoustic specialist no longer has to make any special inputs to the hearing system. Instead, only the results according to the perception of loudness of the user are read in and directly converted in the hearing system.

In order to calibrate the device according to the invention, the space in which the loudspeakers are set up and the sound events are reproduced can be calibrated with a white noise with the aid of a level meter and of a frequency analyzer. The goal here is to adapt the loudspeakers to the environment so that each loudspeaker emits precisely the same level at the end of the calibration up to the customary tolerances. If a reduced construction with only one loudspeaker is used, it is to be calibrated in exactly the same manner. Since all loudspeakers are lined up accordingly, the individual tone- or frequency bands are lined up by a level meter, preferably according to the ISO 226:2003 standard. The goal of the calibration is a high reproducibility in all space sizes.

According to yet another modified embodiment the sound events are also generated and reproduced by the hearing system itself. Therefore, the hearing system made available for the user can be the sound generator itself. In this variant the free sound field is eliminated since the reproduction of the sound events by the loudspeaker system is eliminated, but this leads to an especially simple construction of the device according to the invention.

### BRIEF DESCRIPTION OF THE DRAWINGS

Other details, modifications and advantages of the present invention result from the following description of preferred embodiments using the drawings.

FIG. 1 shows a basic view of a first embodiment of a device according to the invention for the configuration of a user-specific hearing system;

FIG. 2 shows a simplified flow chart of a first embodiment of a method according to the invention for the configuration of a user-specific hearing system;

FIGS. 3a, 3b and 3c show a simplified flow chart of a second embodiment of the method according to the invention; and

FIG. 4 shows a basic view of a second embodiment of the device for the configuration of a user-specific hearing system.

### DETAILED DESCRIPTION

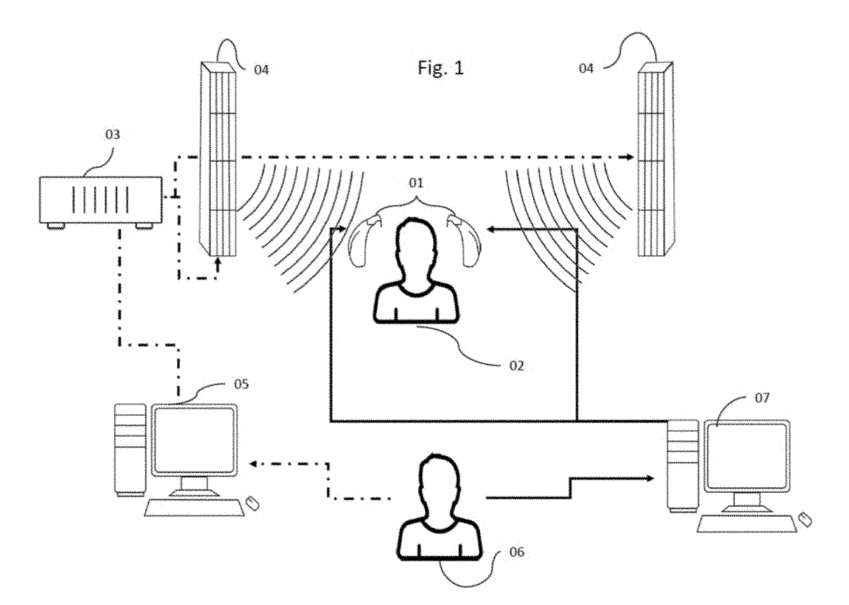

The basic view shown in FIG. 1 illustrates essential components of the device according to the invention for configuring a user-specific hearing system and their cooperation. The user-specific hearing system 01, which does not belong as such to the device according to the invention, comprises one or two hearing devices as partial systems which each comprise a receiving unit for receiving sound events, a converter unit for the frequency-dependent, variable adaptation of the received sound events and a reproduction unit for the reproduction of the amplified sound events to the hearing organ of a user 02.

The hearing system 01 is, for example, a so-called Deep-Fit-Otoplastics or Deep-Fit-CIC hearing devices. The hearing passage of the user is closed to the extent possible by an inserted otoplastic so that only the sound events amplified by the hearing system 01 are supplied to the inner hearing organ of the user 02. The converter unit is formed in such systems by an amplification unit which amplifies the received sound events in a frequency-dependent, variable manner.

However, even modified embodiments of hearing systems can be configured. The received sound events are not obligatorily amplified by such modified hearing systems but rather are processed/adapted in the further sense and supplied, for example, as electrical signals to the hearing organ.

Furthermore, the device according to the invention comprises a sound generator 03 consisting in the exemplary embodiment shown of a system computer and of an amplifier. The sound generator 3 generates sound events (tone signals) and forwards them to a loudspeaker unit 04 by which sound events are emitted. A loudspeaker unit 04 is constructed with two or more channels in the embodiment shown and comprises at least two loudspeakers here which are at a distance from each other and are positioned at a distance from the user 02. The distance relationships preferably result in a position of the user in the free sound field which is suitable for a realistic stereo hearing experience. The user 02 is therefore located in the free sound field so that the sound events reach him like in a natural noise environment.

In modified, simple embodiments the reproduction of the sound events can also be performed by only one individual loudspeaker.

Finally, the device according to the invention comprises a control unit 05. The control unit 05 causes the sound generator 03 to generate several sound events with different frequencies in a predetermined sequence. The generated tone signals are amplified in a predetermined manner and transmitted for reproduction as sound events with the same loudness to the loudspeaker unit. Normed measuring methods for measuring loudness are indicated, for example, in DIN 45631 and ISO 532 B.

Therefore, in the simplest case a first sound event with a frequency of, for example, 2 kHz and a loudness of 65 dB is reproduced by the loudspeaker unit for the user and immediately thereafter a second sound event with an adjacent frequency of 3 kHz and the same loudness. A user with normal hearing would perceive the two sound events as equally loud whereas a user with hearing damage in the frequency range concerned registers a difference in the loudness. The sound events are purposefully reproduced above the hearing threshold of the user in a range of normal environmental loudness, for example, with 45 to 80 dB. A loudness difference perceived by the user is inputted either by the user 02 or by a specialist in hearing devices 06 performing the configuration via an operator interface to the control unit 05. The control unit 05 determines correction values from the received evaluation data for the loudness difference and outputs them in order to adapt the converter unit of the hearing system 01 in such a manner that the loudness difference is reduced or preferably entirely eliminated. The correction values can either be directly fed into a programming unit 07 which adjust the frequency-dependent amplification of the hearing system 01. Alternatively to the above, the correction values can be indicated to the specialist in hearing devices so that he can manually input the corresponding corrections via another interface into the programming unit 07. The correction can be carried out in several successive steps.

Another modified embodiment uses the hearing system itself as a sound generator and for the reproduction of the sound events. The loudspeaker system can be eliminated here.

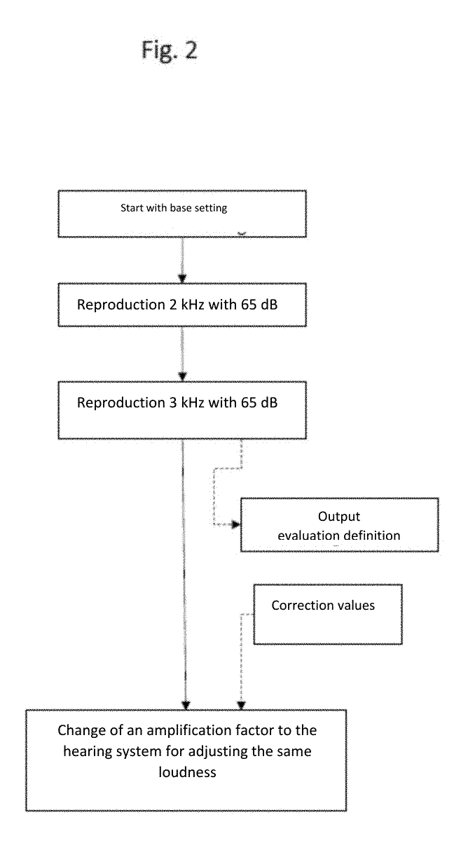

FIG. 2 shows the essential steps for carrying out a method according to the invention in the form of a program flowchart for the configuration of a user-specific hearing system. Prior to the beginning of the actual configuration the hearing system can be adjusted with the basic setting of the manufacturer (First Fit) without the additional loading of frequency-dependent amplification parameters. If the user is supplied with hearing systems on both ears, they are decoupled and at first only the side with a sound event is loaded in the two-channel loudspeaker unit, which side is closer to the better-hearing ear of the user. The actual configuration then begins with the reproduction of a first sound event with a first frequency, e.g. 2 kHz, at a readily perceivable loudness, for example with a loudness of 65 dB, and at first only on one channel of the two-channel loudspeaker unit on the side of the better hearing of the user. Immediately thereafter, a second sound event is reproduced with a second, adjacent frequency, for example 3 kHz and the same loudness, also on the side with the better hearing. The user registers either the same loudness or a difference in loudness in spite of the objectively existing, identical loudness between the two reproduced sound events. A perceived difference in loudness in the form of evaluation data can be inputted via an operator interface to the control unit of an appropriate device, in the simplest case only by selecting the sound event perceived by the user as louder.

Given a difference in loudness, in the next step an amplification factor of the amplification unit (or an appropriate adaptation parameter of a modified converter unit) of the hearing system is changed so that the loudness of the first sound event is perceived by the user of the hearing system as equal to the loudness of the second sound event. The hearing system is therefore configured for the frequency range between the frequencies of the two reproduced, adjacent sound events.

The configuration of the hearing system preferably takes place not only for two sound events which differ from one another in their frequencies, i.e. are adjacent to one another, but also for a plurality of sound events which deviate in their frequency from each other by a predetermined amount, i.e. which are adjacent to each other, e.g. with a frequency interval in the range between 500 and 1200 Hz.

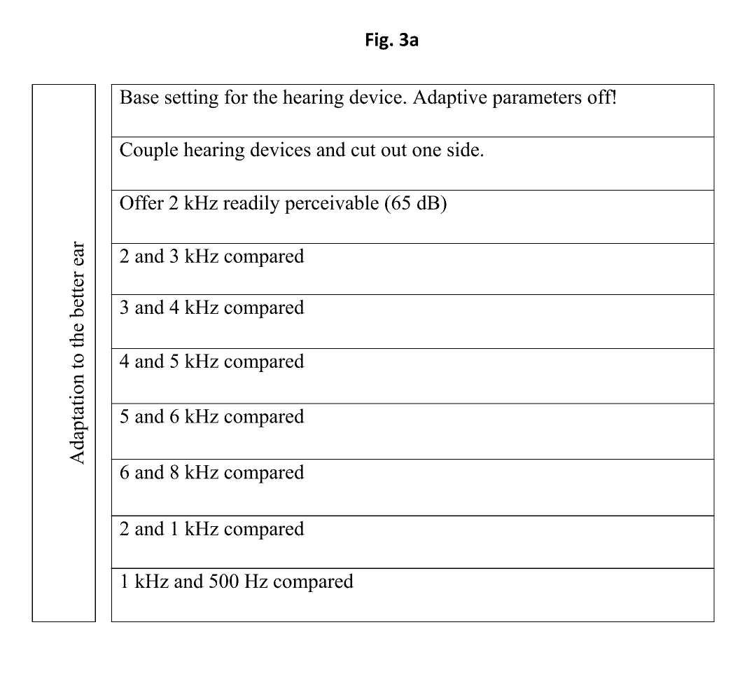

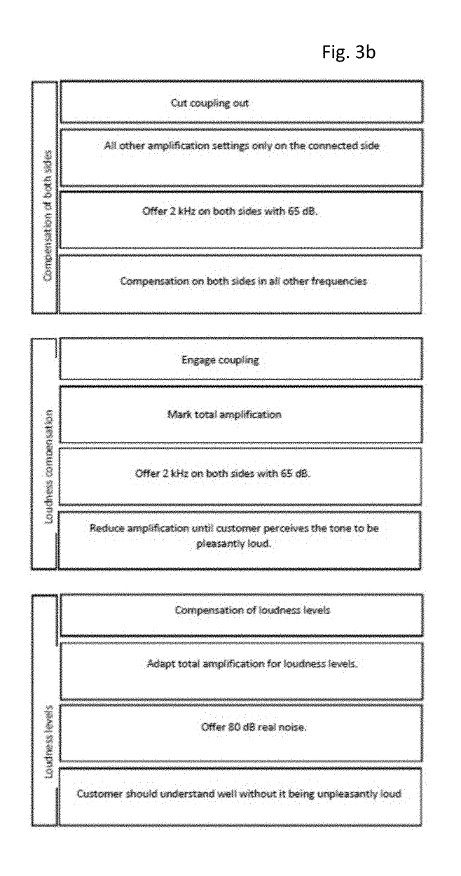

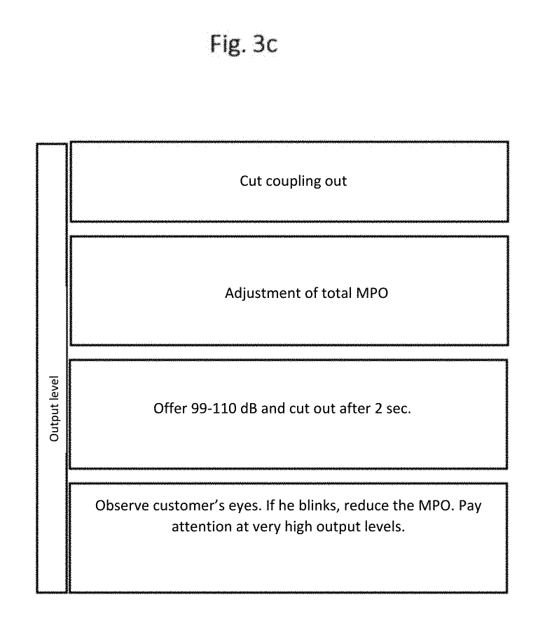

FIGS. 3a-3c show a correspondingly modified embodiment of the method for the configuration of a user-specific hearing system in which the configuration is carried out using more than two sound events.

The section “adaptation to the better ear” shown in FIG. 3a corresponds to the already explained steps according to FIG. 2, wherein several sound events with different frequencies are used. The hearing devices of the user are operated at first in the basic setting and adaptive parameters are cut out. If the user uses two hearing devices, they are coupled and one side (a partial system) is cut out. In the next step a first sound event is reproduced with, for example, 2 kHz, 65 dB so that the user perceives this first sound event with a distinct loudness. In the next step a second sound event is reproduced for the user with an adjacent frequency of, e.g. 3 kHz and the same loudness as the first sound event. The user can directly compare the two sound events with adjacent frequencies and the same loudness and indicate whether the second sound event is perceived as louder or softer. In the case of a deviation in the subjectively perceived loudness, a correction value/amplification factor is used so that the user then perceives approximately the same loudness. The selection of the correct amplification factor can optionally take place in several successive partial steps. A further comparison follows between adjacent frequencies, for example, 3 and 4 kHz, 4 and 5 kHz, 5 and 6 kHz and 6 and 8 kHz, wherein correction values are determined for the hearing device which result in the perception of the particular two sound events with adjacent frequencies with the same loudness. Other steps in the lower frequency range can follow by a comparison of sound events at, for example, 2 and 1 kHz as well as 1 kHz and 500 kHz.

In the following sections of the flowcharts according to FIGS. 3b and 3c those steps are also shown which are required for the configuration of the second hearing system (on the second ear) (section “two-sided compensation”) and which can be additionally carried out for a conclusive adjustment of the hearing system as regards the adjusting of the perception threshold and the adjusting of the maximum amplification of the hearing systems. Both hearing systems of the user are preferably coordinated with one another binaurally by alternately offering the sound results.

As is apparent from FIG. 3b, at first the coupling of the two hearing devices is cut out in the section “two-sided compensation”. All other amplification adjustments take place in this section only on the cut-in side (hearing device). At first, a sound event with 2 kHz, 65 dB is offered to the added-in, second hearing device. The compensation in all other frequencies follows, as was previously described.

Concluding adjustments follow in the section “loudness compensation”, in the section “loud level” and in the section “output level” (FIG. 3c).

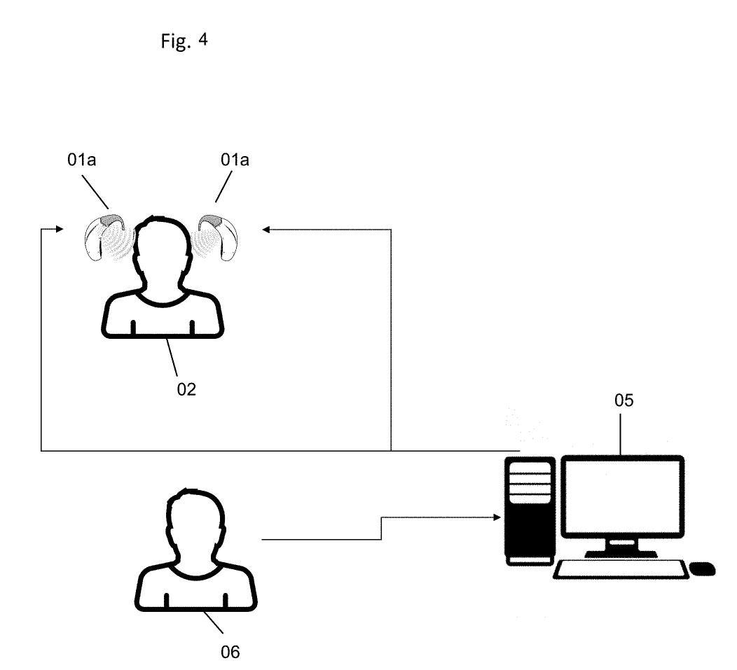

FIG. 4 shows a modified embodiment of the device for the configuration of a user-specific hearing system 01a. Here the hearing system itself is used as sound generator as well as for the reproduction of the sound events. The adopted, user-specific hearing system 01a also comprises in this case one or two hearing devices as partial systems which each comprise a receiving unit for the receiving of sound events, a converter unit for the frequency -dependent, variable adaptation of the received sound events and the reproduction unit for the reproduction of the amplified sound events to the hearing organ of a user 02.

Furthermore, the hearing system 01a and each partial system comprises an integrated unit which functions as sound generator and is activated by the control unit 05. The integrated sound generator generates sound events and forwards them directly by the reproduction unit of the hearing system 01a. The control unit 05 causes the hearing system to generate several told signals with different frequencies in a predetermined sequence and to reproduce them with the same loudness. A difference in loudness perceived by the user 02 is inputted by an operator interface to the control unit 05 either by the user or by a special listing hearing devices 06 carrying out the configuration. The control unit 05 determines correction values from the received evaluation data for the difference in loudness and outputs them in order to adapt the converter unit of the hearing system 01 in such a manner that the difference in loudness is reduced or is preferably entirely eliminated. The correction values are supplied in this case directly to the hearing system 01 by the control unit 05.

### LIST OF REFERENCE NUMERALS

01—Hearing system

02—User

03—Sound generator

04—Loudspeaker unit

05—Control unit

06—Specialist in hearing devices

07—Programming unit

1. A method for configuring a user-specific hearing system, wherein the hearing system comprises a receiving unit for receiving sound events, a converter unit for the frequency-dependent, variable adaptation of the received sound events and a reproduction unit for the reproduction of the amplified sound events to the hearing organ of a user, wherein the method comprises the following steps:
a) reproduction of a first sound event with a first frequency and a predetermined loudness via at least one sound generator;
b) reproduction of a second sound event with a second frequency and the same loudness as the first sound event via the sound generator, wherein the frequencies of the first and of the second sound event are adjacent to one another; and
c) changing at least one adaptation parameter of the converter unit of the hearing system so that the loudness of the first sound event is perceived by the user of the auditory system as equal to the loudness of the second sound event.

2. The method according to claim 1, wherein the steps a) to c) are repeated for other sound events with other frequencies, wherein the selected frequencies correspond to those frequencies for which frequency-specific amplification factors can be adjusted on the hearing system.

3. The method according to claim 1, wherein the adjacent frequencies of the first and of the second sound events are at a distance from one another of approximately 500 to 1200 Hz, preferably 1 kHz±200 Hz, especially preferably 1 kHz±100 Hz.

4. A method for configuring a user-specific hearing system, wherein the hearing system comprises a first and a second partial system, each of which comprises a receiving unit for receiving sound events, a converter unit for the frequency-dependent, variable adaptation of the received sound events and a reproduction unit for the reproduction of the amplified sound events to the first and second hearing organ of a user, wherein the method comprises the following steps:
i) reproduction of a first sound event with a first frequency and a predetermined loudness via the sound generator of the first partial system;
ii) reproduction of a second sound event with the first frequency and the same loudness as the first sound event via the sound generator of the second partial system; and
iii) changing at least one adaptation parameter of the converter unit of the hearing system so that the loudness of the first sound event is perceived by the user of the auditory system as equal to the loudness of the second sound event.

5. The method according to claim 4, wherein at first, the first partial system of the hearing system is configured according to the following steps:
a) reproduction of a first sound event with a first frequency and a predetermined loudness via at least one sound generator;
b) reproduction of a second sound event with a second frequency and the same loudness as the first sound event via the sound generator, wherein the frequencies of the first and of the second sound event are adjacent to one another; and
c) changing at least one adaptation parameter of the converter unit of the hearing system so that the loudness of the first sound event is perceived by the user of the auditory system as equal to the loudness of the second sound event and in that subsequently the steps i) to iii) are executed.

6. The method according to claim 1, wherein the reproduced sound events are sinusoidal tones, thirds or narrow-band noise.

7. A method according to claim 1, wherein one or more loudspeakers at a distance from the user of the hearing system or the hearing system of the user is used as sound generator.

8. A method for configuring a user-specific hearing system, wherein the hearing system comprises a receiving unit for receiving sound events, a converter unit for the frequency-dependent, variable adaptation of the received sound events and a reproduction unit for the reproduction of the adapted sound events to the hearing organ of a user, wherein the device comprises:
a sound generator for generating sound events;
at least one loudspeaker at a distance from the user of the hearing system;
a control unit, which
causes the sound generator to generate several sound events with different frequencies in a predetermined sequence,
amplifies the generated tone signals in a predetermined manner and transmits them for reproduction as sound events with the same loudness to the loudspeaker unit,
receives evaluation data via an operating interface which represent a loudness difference between a first and a second sound event perceived by the user, wherein the frequencies of the first and of the second sound event are adjacent; and
outputs correction values which can be used in the hearing system in order to configure its converter unit in such a manner that the perceived loudness difference is reduced or eliminated.

9. The device for configuring a user-specific hearing system, wherein the hearing system comprises a receiving unit for receiving sound events, a converter unit for the frequency-dependent, variable adaptation of the received sound events and a reproduction unit for the reproduction of the adapted sound events to the hearing organ of a user, wherein the device comprises a control unit which:
causes the hearing system to generate several sound events with different frequencies in a predetermined sequence and reproduces the generated sound events in a predetermined manner amplified as sound events with the same loudness,
receives evaluation data via an operating interface which represent a loudness difference between a first and a second sound event perceived by the user, wherein the frequencies of the first and of the second sound event are adjacent; and
outputs correction values which can be used in the hearing system in order to configure its converter unit in such a manner that the perceived loudness difference is reduced or eliminated.

10. The device according to claim 8, wherein the adjacent frequencies of the first and second sound events are at a distance from one another of approximately 500 to 1200 Hz, preferably of approximately 1 kHz+200 Hz, especially preferably of 1 kHz+100 Hz.

11. The device according to claim 8, wherein the converter unit is an amplification unit which amplifies the sound events in a frequency-dependent, variable manner.

12. The device according to claim 8, wherein the loudspeaker is formed by a multichannel loudspeaker unit comprising at least two loudspeakers at a distance from each other as well as from the user of the hearing system.

13. The device according to claim 8, wherein the operator interface comprises an input unit and a display unit.

14. The device according to claim 8, wherein it comprises a temporary data connection to the hearing system via which the correction values are transmitted to the hearing system.

15. A method according to claim 4, wherein one or more loudspeakers at a distance from the user of the hearing system or the hearing system of the user is used as sound generator.

16. The device according to claim 9, wherein the adjacent frequencies of the first and second sound events are at a distance from one another of approximately 500 to 1200 Hz, preferably of approximately 1 kHz+200 Hz, especially preferably of 1 kHz+100 Hz.

17. The device according to claim 9, wherein the converter unit is an amplification unit which amplifies the sound events in a frequency-dependent, variable manner.

18. The device according to claim 9, wherein the operator interface comprises an input unit and a display unit.

19. The device according to claim 9, wherein it comprises a temporary data connection to the hearing system via which the correction values are transmitted to the hearing system.
